(19) United States
(12) Patent Application Publication
(10) Pub. No.: US 2021/0127607 A1
(43) Pub. Date: May 6, 2021

(54) Drainable Aerating Hydroponics System

(71) Applicant: Ian Taylor, Van Nuys, CA (US)

(72) Inventor: Ian Taylor, Van Nuys, CA (US)

(21) Appl. No.: 17/089,601

(22) Filed: Nov. 4, 2020

Related U.S. Application Data
(60) Provisional application No. 62/930,466, filed on Nov. 4, 2019.

(51) Int. Cl. A01G 31/02; A01G 7/04

(52) U.S. Cl. CPC A01G 31/02; A01G 2031/006; A01G 7/045

(57) ABSTRACT

A drainable aerating hydroponics system is used to facilitate the growth of different crops in an efficient and simple manner. The system includes a heat management enclosure, a water reservoir, a perforated basket, a capillary tube, spouts, an aerator, and a drain valve. The heat management enclosure is portable and houses the water reservoir. The water reservoir contains the water and nutrients necessary for the crops. Together with the heat management enclosure, the water reservoir maintains the water under ideal conditions for the crops. The perforated basket supports the growing crops and material necessary for the crops. The capillary tube guides the flow of water and nutrients from the water reservoir to the spouts. The spouts distribute the water flow from the capillary tube to the crops on the perforated basket. The aerator aerates the water within the water reservoir. The drain valve enables the gravity flushing of the water.

The current application claims a priority to the U.S. Provisional Patent application Ser. No. 62/930,466 filed on Nov. 4, 2019.

### FIELD OF THE INVENTION

The present invention generally relates to hydroponics and indoor gardening systems. More specifically, the present invention provides a drainable aerating hydroponics system for growing various plants with novel irrigation and drainage mechanisms integrated into a portable enclosure.

### BACKGROUND OF THE INVENTION

Indoor gardening has risen in popularity due to effectiveness and relative high yield that can be obtained as compared to traditional outdoor gardening. Various indoor gardening systems and methods are available, with hydroponics being one of the most popular nowadays. Hydroponics enables growing crops without the use of soil, which is perfect for indoors. However, most systems can be cumbersome and expensive to operate. Various pumping mechanisms for keeping the flow of water with the nutrients are often necessary in addition to other systems needed to monitor the growth of the crops. As a result, the overall hydroponics system can be difficult to maintain and operate. An objective of the present invention is to provide a hydroponics system with a novel irrigation and drainage mechanisms which maintain a desired flow of nutrients to the growing plants.

The present invention, also referred to as the Xyphlo, utilizes capillary action to deliver a constant flow of nutrients to the plants. The fluid is contained within a reservoir with integrated draining mechanism. The draining mechanism is gravity aided to enable draining of the reservoir without the use of a pump or other pressure mechanism. An aeration mechanism is also provided to constantly deliver a desired gas to the fluid containing the nutrients for the plants. Further, the fluid from the reservoir can be drained for disposal or recycled to flow to other units of the present invention. Multiple units of the present invention can be operated together with nutrients being utilized and recycled among the multiple units.

Furthermore, a trellis or similar structure can be mounted on top of the unit to help support the growth of the crops with multiple attachments that can be added to provide vertical support to the growing crops. Finally, the present invention provides a controller to monitor and control the operation of one or more units. The controller enables the monitoring of multiple variables of the system such as humidity, pH, ppm, temperature, light intensity, etc. In some embodiments, the controller can transmit data from various sensors including, but not limited to, humidity meter, lumens meter, barcode emitter, hygrometer, and lumens counter to a wireless electronic device for remote monitoring. Additional features and benefits are further discussed in the sections below.

### BRIEF DESCRIPTION OF THE DRAWINGS

FIG. 1 is a top perspective view showing the heat management enclosure of the present invention.

FIG. 2 is a top exploded perspective view showing the heat management enclosure and the perforated basket of the present invention.

FIG. 3 is a front view showing the heat management enclosure of the present invention.

FIG. 4 is a vertical cross-sectional view taken along the line 4-4 in FIG. 3.

FIG. 5 is a side view showing the heat management enclosure of the present invention.

FIG. 6 is a vertical cross-sectional view taken along the line 6-6 in FIG. 5.

FIG. 7 is a magnified view of the inner reservoir surface and the outer reservoir surface taken about circle 7 in FIG. 4.

FIG. 8 is a top exploded perspective view showing the perforated basket and the taproot holder of the present invention.

FIG. 9 is a bottom exploded perspective view showing the perforated basket and the taproot holder of the present invention.

FIG. 10 is a side view showing the taproot holder within the perforated basket of the present invention.

FIG. 11 is a vertical cross-sectional view taken along the line 11-11 in FIG. 10.

FIG. 12 is a top view showing the perforated basket of the present invention.

FIG. 13 is a top perspective view showing the heat management enclosure with the trellis and the at least one light source of the present invention.

FIG. 14 is a schematic view showing the fluid communication of the different fluid components of the present invention.

FIG. 15 is a schematic view showing the electronic and electrical connections of the different electrical components of the present invention.

### DETAILED DESCRIPTION OF THE INVENTION

All illustrations of the drawings are for the purpose of describing selected versions of the present invention and are not intended to limit the scope of the present invention.

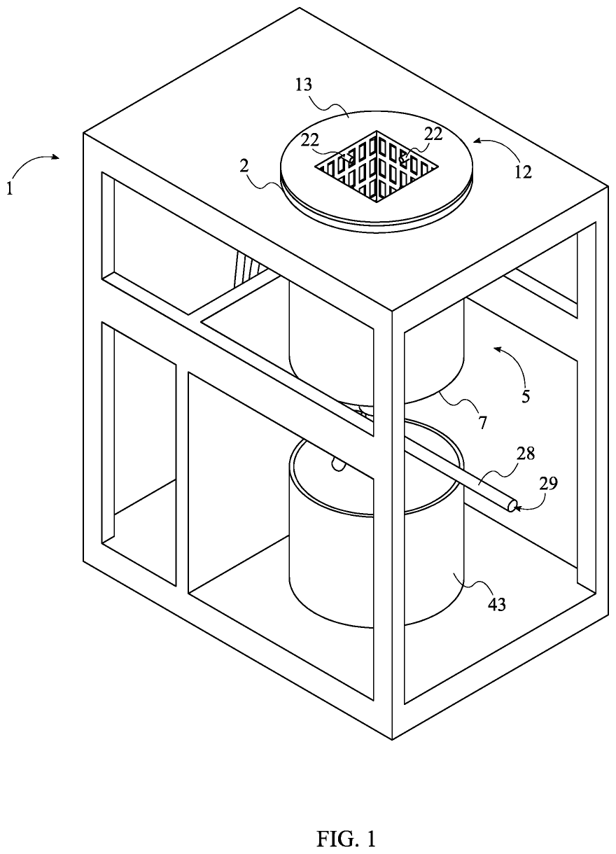

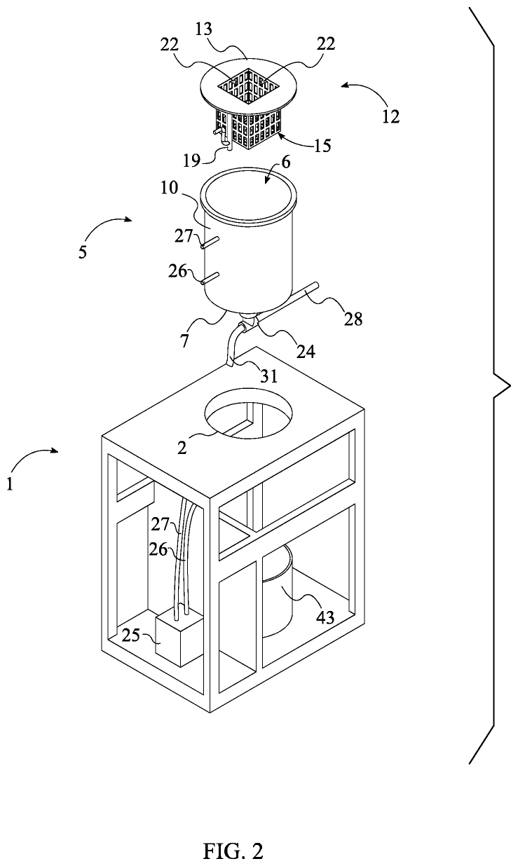

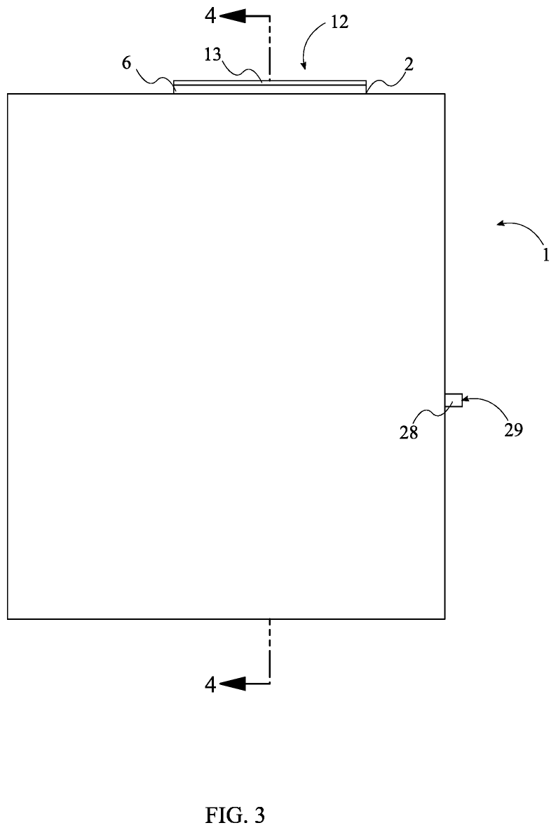

The present invention is a drainable aerating hydroponics system which facilitates the growth of different crops in an efficient and relatively simple manner. The present invention may comprise a heat management enclosure 1, a water reservoir 5, a perforated basket 12, at least one capillary tube 19, a plurality of spouts 22, an aerator 23, and a drain valve 24. As can be seen in FIG. 1 through 4, the heat management enclosure 1 is a portable structure that houses the water reservoir 5. The water reservoir 5 contains the appropriate amount of water necessary for the growth of the different crops. Together with the heat management enclosure 1, the water reservoir 5 maintains the contained water under specific ideal conditions for the growth of the crops. The perforated basket 12 supports the growing crops and the material necessary for the growth of the crops. The at least one capillary tube 19 guides the appropriate flow of water and nutrients from the water reservoir 5 to the plurality of spouts 22. The plurality of spouts 22 distributes the water flow from the at least one capillary tube 19 to the growing crops on the perforated basket 12. The aerator 23 facilitates the aeration of the water contained within the water reservoir 5 using different gases. The drain valve 24 enables the gravity flushing of the water reservoir 5.

The general configuration of the aforementioned components allows the present invention to effectively and efficiently grow crops via hydroponics without requiring the use of water pumps to maintain the necessary water and nutrients for the growth of crops. As can be seen in FIG. 1 through 4, the heat management enclosure 1 comprises a reservoir-receiving opening 2 to facilitate the insertion of the water reservoir 5 into the heat management enclosure 1. The heat management enclosure 1 is preferably shaped into an overall rectangular design. However, the heat management enclosure 1 can alternatively be shaped into non-rectangular designs matching the design of the water reservoir 5, such as having a cylindrical design. The water reservoir 5 comprises an open reservoir end 6 and a closed reservoir end 7, which are respectively used to receive and contain the water and nutrients necessary for the growth of crops. The water contained within the water reservoir 5 can be mixed with multiple nutrients appropriate for the growth of different crops. Further, the perforated basket 12 comprises a basket rim 13, and the at least one capillary tube 19 comprises a tube inlet 20 and a tube outlet 21. The water reservoir 5 is mounted within the heat management enclosure 1 to maintain the contained water within a desired temperature range. The open reservoir end 6 is positioned coincident to the reservoir-receiving opening 2 to keep the open reservoir end 6 accessible from the exterior of the heat management enclosure 1. The closed reservoir end 7 is positioned offset from the reservoir-receiving opening 2 to provide a desired volumetric space to hold a desired amount of water and nutrients.

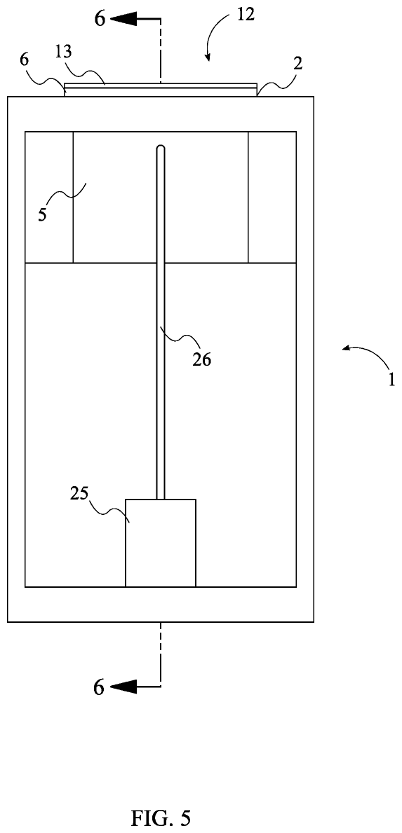

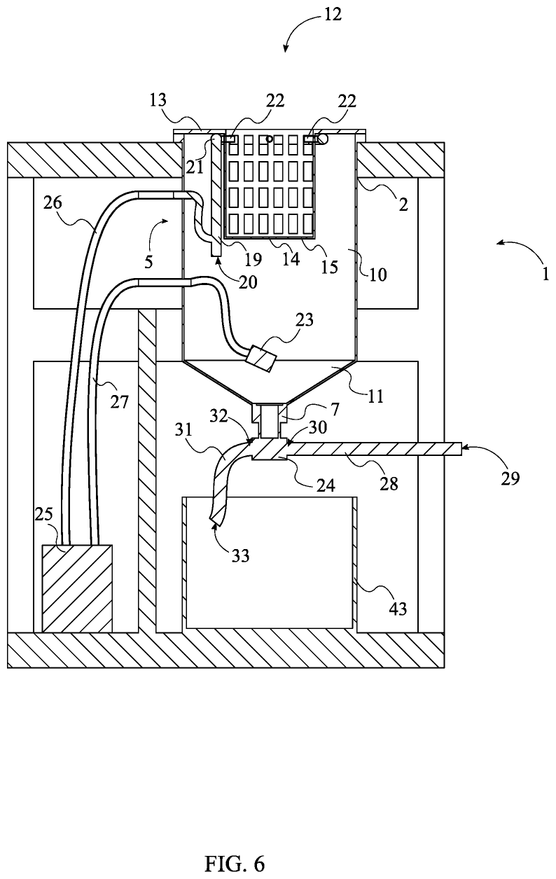

As can be seen in FIGS. 5 and 6, the perforated basket 12 is mounted within the water reservoir 5 to maintain the roots of the growing crops within the water reservoir 5. The perforated basket 12 also enables excess water to flow back into the water reservoir 5. The basket rim 13 is positioned coincident with the open reservoir end 6 to enable the vertical growth of the growing crops. Further, the at least one capillary tube 19 is laterally mounted to the perforated basket 12 to guide the water flow from within the water reservoir 5 to the plurality of spouts 22. The at least one capillary tube 19 is designed to enable water flow from the water reservoir 5 to the plurality of spouts 22 via capillary action. The plurality of spouts 22 is mounted around the basket rim 13 to distribute the water flow from the at least one capillary tube 19 to all areas within the perforated basket 12. The plurality of spouts 22 can be inserted into the perforations of the perforated basket 12, and the plurality of spouts 22 is arranged to supply water to all areas within the perforated basket 12. The tube inlet 20 is positioned adjacent to the closed reservoir end 7 so the tube inlet 20 is always in contact with the contained water. The tube outlet 21 is in fluid communication with each of the plurality of spouts 22 to enable the water flow from the at least one capillary tube 19 to the plurality of spouts 22. Furthermore, the aerator 23 is positioned within the water reservoir 5 to aerate the contained water inside the water reservoir 5. The drain valve 24 is integrated into the closed reservoir end 7 to enable the gravity flushing of the water reservoir 5.

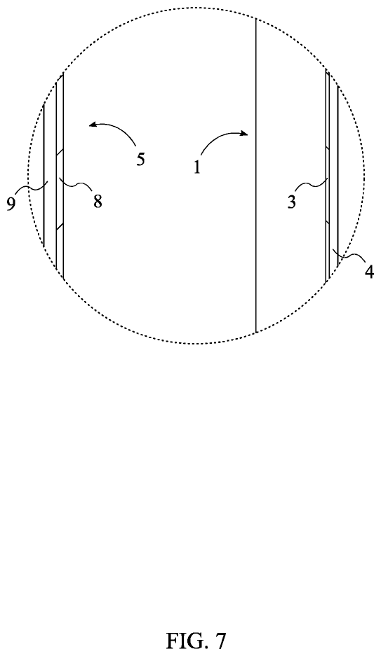

The heat management enclosure 1 and the water reservoir 5 are both designed to prevent the heating of the water contained within the water reservoir 5 to prevent the growth of bacteria and other undesired microorganisms. As can be seen in FIGS. 6 and 7, The water reservoir 5 may further comprise an inner reservoir surface 8 and an opaque color coating 9. The opaque color coating 9 is superimposed across the inner reservoir surface 8 to absorb heat from the water within the water reservoir 5. The opaque color coating 9 is preferably a black-colored waterproof coating. Likewise, the heat management enclosure 1 may further comprise an outer enclosure surface 3 and a reflective coating 4. The reflective coating 4 is superimposed across the outer enclosure surface 3 to prevent the heating of the inside of the heat management enclosure 1. The reflective coating 4 is preferably a light-colored weatherproof coating.

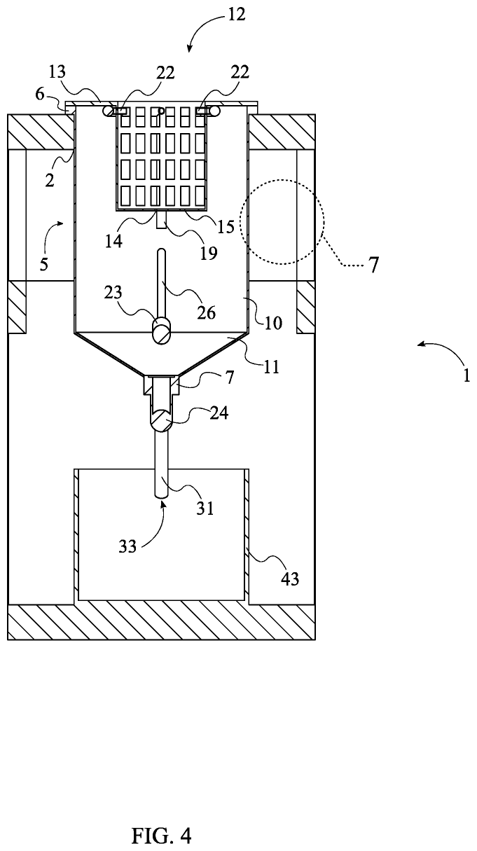

To facilitate the gravity flushing of the water reservoir 5, the water reservoir 5 may further comprise a cylindrical-shaped portion 10 and a conical-shaped portion 11. As can be seen in FIGS. 4 and 6, the cylindrical-shaped portion 10 is positioned in between the open reservoir end 6 and the conical-shaped portion 11 so the water reservoir 5 has an overall funneling design. The conical-shaped portion 11 is positioned between the cylindrical-shaped portion 10 and the closed reservoir end 7 to increase the speed of the gravity flush. Furthermore, the conical-shaped portion 11 is oriented away from the cylindrical-shaped portion 10 to guide the flushed water within the water reservoir 5 towards the drain valve 24. The closed reservoir end 7 preferably corresponds to the vertex of the conical-shaped portion 11.

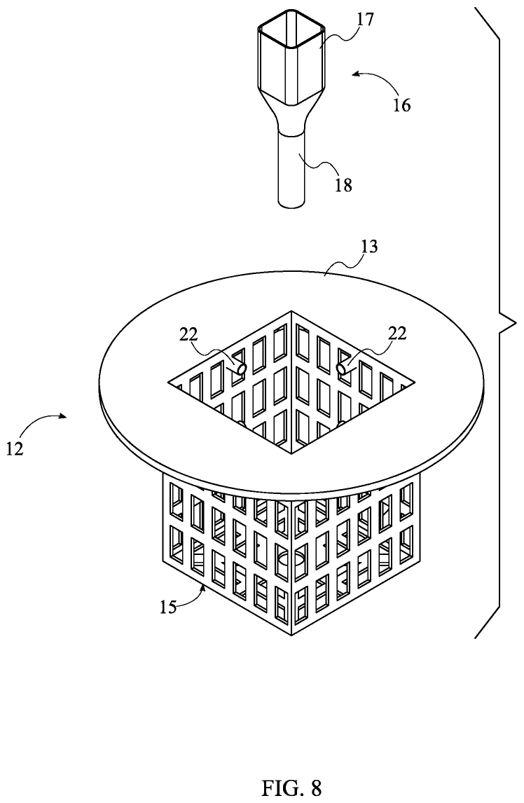

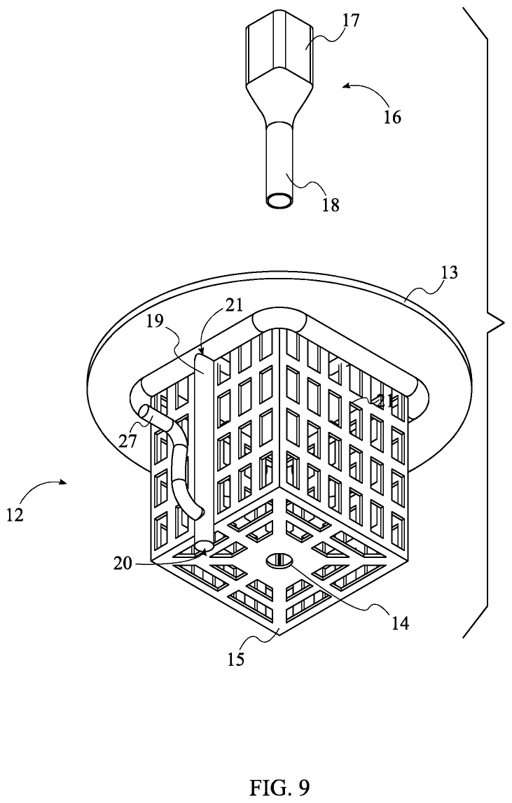

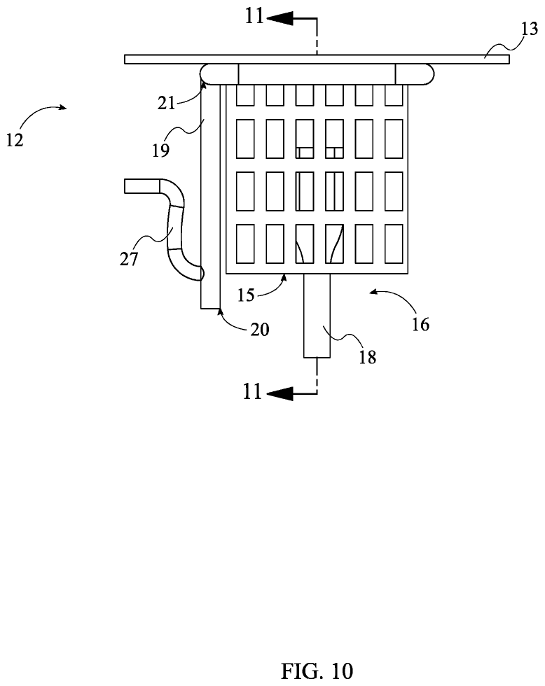

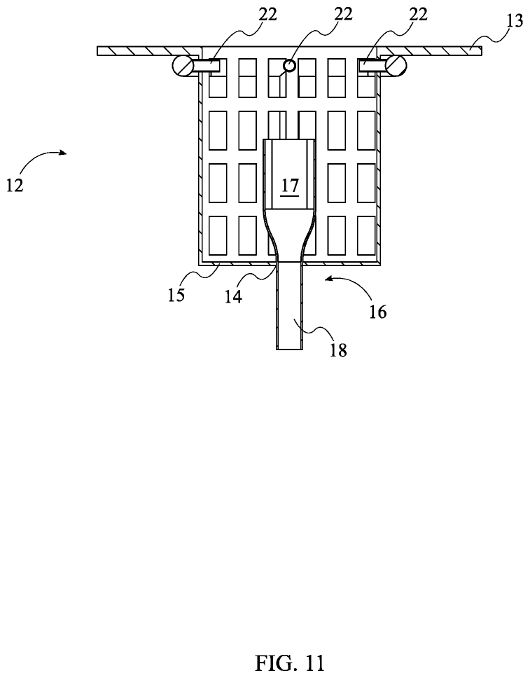

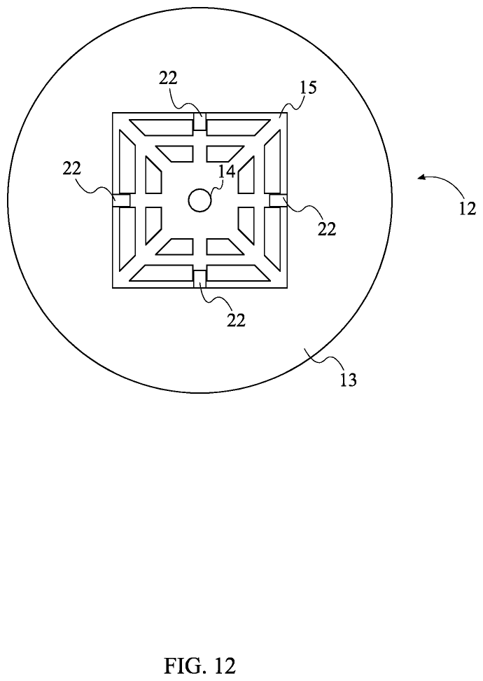

To enable the growth of new crops from existing crops, the present invention may further comprise a taproot holder 16. As can be seen in FIGS. 8 and 9, the taproot holder 16 comprises a lateral brace 17 and an elongated hollow guide 18. The lateral brace 17 holds and supports the taproot of the new crop. The lateral brace 17 preferably has a rectangular, hollow design that is large enough to receive the taproot and other growth materials. The elongated hollow guide 18 enables the downward growth of the taproot into the water reservoir 5. Further, the lateral brace 17 and the elongated hollow guide 18 can each be made from paper, carton, or similar materials. In addition, the perforated basket 12 may further comprise a guide-receiving hole 14 and a basket base 15. As can be seen in FIG. 10 through 12, the guide-receiving hole 14 enables the user to vertically position the taproot holder 16 within the perforated basket 12. The basket base 15 supports the taproot holder 16 as well as other grow material, such as pebbles or clay balls, to support the growth of the crops. The basket base 15 is positioned opposite the basket rim 13 about the perforated basket 12 to provide enough space to contain the lateral brace 17 and other growth material. The basket base 15 may also comprise multiple perforations to enable excess water to flow back into the water reservoir 5. The lateral brace 17 is terminally connected to the elongated hollow guide so that the taproot can grow from the lateral brace 17, through the elongated hollow guide 18, and into the water reservoir 5. Further, the elongated hollow guide 18 traverses through the guide-receiving hole 14 to guide the taproot into the water reservoir 5. To place a taproot in the taproot holder 16, the taproot or clone is inserted into rockwool or similar materials, which are then inserted into the lateral brace 17. The elongated hollow guide 18 is then inserted into the guide-receiving hole 14, and clay balls or other grow material are placed within the perforated basket 12 surrounding the lateral brace 17 with the taproot.

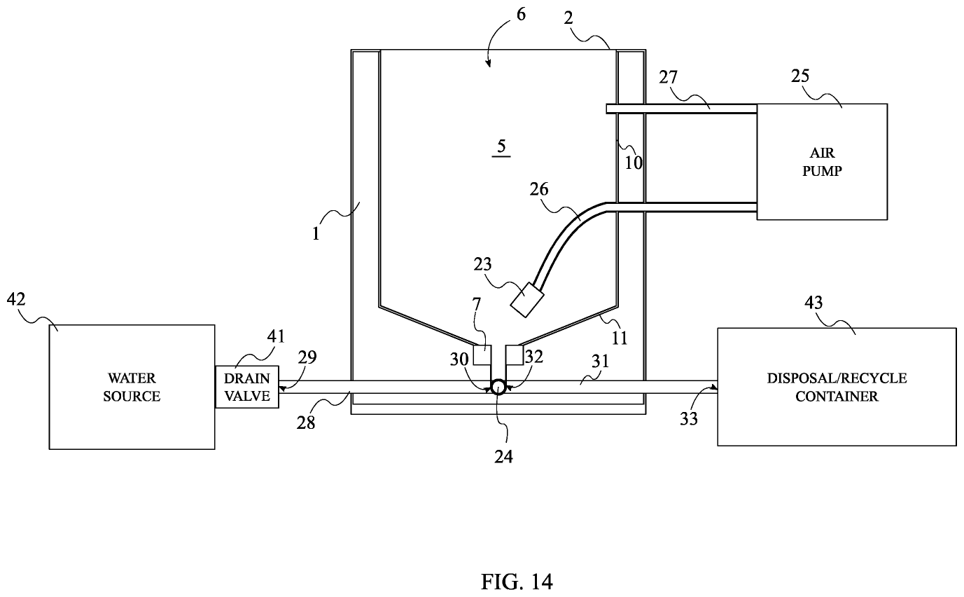

To provide the desired gases to aerate the water contained within the water reservoir 5, the present invention may further comprise an air pump 25. As can be seen in FIGS. 4 and 14, the present invention may further comprise a first flexible tube 26 and a second flexible tube 27 to enable the gas flow into the water reservoir 5. The air pump 25 can supply various gases such as Carbon Dioxide, Oxygen, or other suitable gases for the growth of the crops or to maintain healthy bacteria levels within the water reservoir 5. The air pump 25 is externally positioned to the water reservoir 5 to prevent the air pump 25 from contacting the water contained within the water reservoir 5. The air pump 25 is in fluid communication with the aerator 23 through the first flexible tube 26 to pump the desired gases. In some embodiments, the aerator 23 can be an air stone that that diffuses the pumped gases into the water contained within the water reservoir 5. In addition, the air pump 25 is in fluid communication with the at least one capillary tube 19 through the second flexible tube 27 to facilitate the water flow through the at least one capillary tube 19 via capillary action.

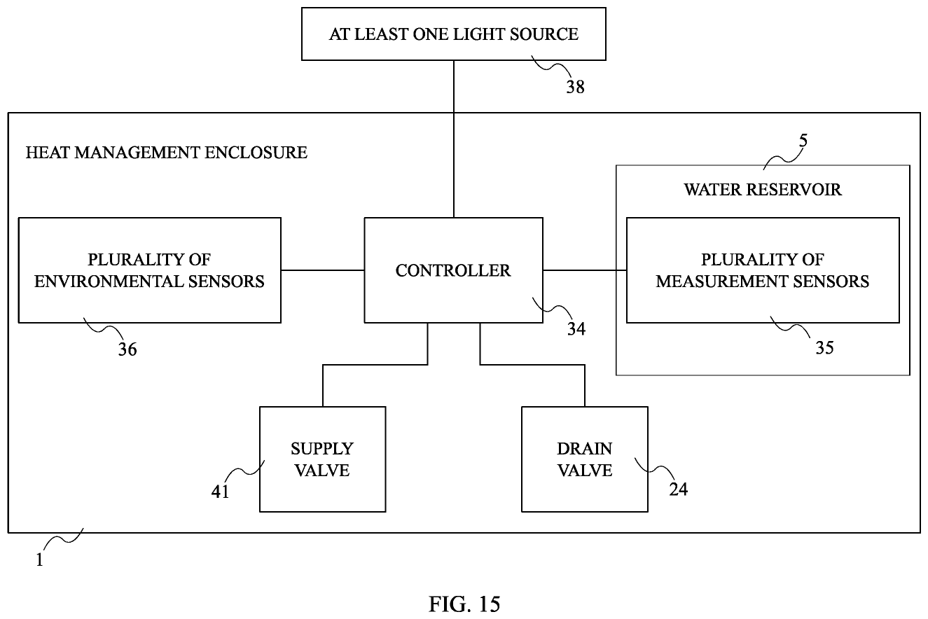

As can be seen in FIGS. 14 and 15, the present invention may further comprise at least one supply tube 28 to maintain the supply of water and nutrients to the water reservoir 5. The at least one supply tube 28 comprises a supply inlet 29 and a supply outlet 30. The supply inlet 29 is externally positioned to the heat management enclosure 1 to connect to an external nutrient and/or water source 42. In one embodiment, the supply inlet 29 can be in fluid communication to a water source 42 or to another unit of the present invention to refill the water and the nutrients in the water reservoir 5. Further, the supply outlet 30 is in fluid communication with the drain valve 24 to guide the water supply flow into the water reservoir 5 through the drain valve 24. The supply inlet 29 can be equipped with a supply valve 41 to control the water inflow into the water reservoir 5. In different embodiments, the water reservoir 5 can be manually filled by pouring water and nutrients through the open reservoir end 6.

The present invention may further comprise at least one drain tube 31 to dispose of or recycle the gravity flushed water from the water reservoir 5. As can be seen in FIG. 1 through 14, the at least one drain tube 31 comprises a drain inlet 32 and a drain outlet 33. The drain inlet 32 is in fluid communication with the drain valve 24 to enable the outflow of the gravity flushed water out of the water reservoir 5. The drain outlet 33 is externally positioned to the heat management enclosure 1 to guide the water outflow out of the heat management enclosure 1 to a drain, a disposal/recycling container 43, or another unit of the present invention. The disposal/recycling container 43 can be integrated into the heat management enclosure 1, adjacent to the closed reservoir end 7, to contain the gravity flushed water until ready for disposal or recycling.

To enable the user to monitor the operation of the present invention, the present invention may further comprise a controller 34, a plurality of measurement sensors 35, and a plurality of environmental sensors 36. The controller 34 enables the user to visually monitor the growth conditions within the water reservoir 5 and the surroundings of the heat management enclosure 1. As can be seen in FIG. 15, the plurality of measurement sensors 35 is operatively integrated into the water reservoir 5, wherein the plurality of measurement sensors 35 is used to monitor a set of measurable conditions within the water reservoir 5. The plurality of measurement sensors 35 can include, but is not limited to, a pH meter, a ppm sensor, a lumen counter, and a hygrometer. The plurality of environmental sensors 36 is operatively integrated into the heat management enclosure 1, wherein the plurality of environmental sensors 36 is used to a set of environmental conditions around the heat management enclosure 1. The plurality of environmental sensors 36 can include, but is not limited to, a humidity meter and a lumens meter/counter to measure light intensity. Further, the controller 34 is electronically connected to the plurality of environmental sensors 36 and the plurality of measurement sensors 35 to receive the measurement signals from both the plurality of environmental sensors 36 and the plurality of measurement sensors 35. The controller 34 can be powered by a power source internally mounted onto the heat management enclosure 1. The power source can include rechargeable or replaceable batteries. The power source can also include one or more solar panels to recharge the rechargeable batteries. Furthermore, the power source can be connected to external power, such as the power utilities of the surrounding facilities.

In some embodiments, the controller 34 may comprise a wireless transceiver to send sensor data from the plurality of environmental sensors 36 and the plurality of measurement sensors 35 to a designated wireless electronic device. The wireless electronic device may comprise a user interface to enable the user to remotely monitor the operation of the present invention. Further, the user can wirelessly transmit commands to the controller 34 to control the operation of the present invention. As can be seen in FIG. 15, the controller 34 can be electrically connected to the drain valve 24 and the supply valve 41 to selectively open or close either the drain valve 24 or the supply valve 41, or both, to control the water flow into and out of the water reservoir 5.

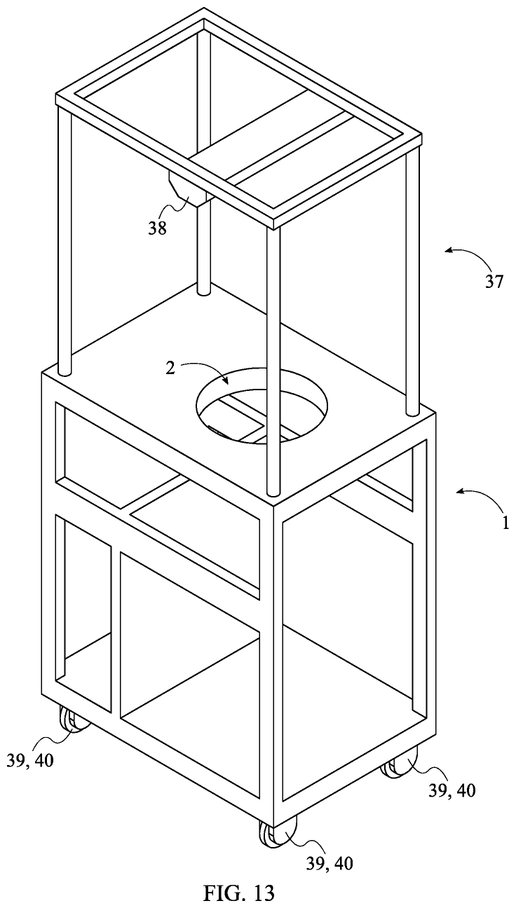

To provide external support to the growing crops, the present invention may further comprise a trellis 37 and at least one light source 38. As can be seen in FIG. 13, the trellis 37 supports the growing crops so the crops grow vertically on top of the heat management enclosure 1. The at least one light source 38 provides the right lighting conditions for the efficient growth of the crops. The trellis 37 is externally mounted to the heat management enclosure 1 to support the crops growing outside the perforated basket 12. The trellis 37 is also positioned adjacent to the reservoir-receiving opening 2 to receive all growing crops. The at least one light source 38 is mounted offset from the reservoir-receiving opening 2 by the trellis 37 to provide the right lighting conditions to all the growing crops. In some embodiments, the at least one light source 38 is electrically connected to the controller 34 to allow the user to remotely turn on or off the at least one light source 38 as well as to control the intensity of the at least one light source 38.

Finally, to make the heat management enclosure 1 portable, the present invention may further comprise a wheel assembly 39. As can be seen in FIGS. 1 and 13, the wheel assembly 39 is externally mounted to the heat management enclosure 1. The wheel assembly 39 is also positioned opposite to the reservoir-receiving opening 2 about the heat management enclosure 1 to keep the growing crops away from the floor. In some embodiments, the wheel assembly 39 may comprise a plurality of wheels 40 distributed about the bottom corners of the heat management enclosure 1. Further, one or more wheels of the plurality of wheels 40 comprise a brake mechanism to keep the heat management enclosure 1 in place.

Although the invention has been explained in relation to its preferred embodiment, it is to be understood that many other possible modifications and variations can be made without departing from the spirit and scope of the invention as hereinafter claimed.

What is claimed is:

1. A drainable aerating hydroponics system comprising:
a heat management enclosure;
a water reservoir;
a perforated basket;
at least one capillary tube;
a plurality of spouts;
an aerator;
a drain valve;
the heat management enclosure comprising a reservoir-receiving opening;
the water reservoir comprising an open reservoir end and a closed reservoir end;
the perforated basket comprising a basket rim;
the at least one capillary tube comprising a tube inlet and a tube outlet;
the water reservoir being mounted within the heat management enclosure;
the open reservoir end being positioned coincident to the reservoir-receiving opening;
the closed reservoir end being positioned offset from the reservoir-receiving opening;
the perforated basket being mounted within the water reservoir;
the basket rim being positioned coincident with the open reservoir end;
the at least one capillary tube being laterally mounted to the perforated basket;
the plurality of spouts being mounted around the basket rim;
the tube inlet being positioned adjacent to the closed reservoir end;
the tube outlet being in fluid communication with each of the plurality of spouts;
the aerator being positioned within the water reservoir; and,
the drain valve being integrated into the closed reservoir end.

2. The drainable aerating hydroponics system as claimed in claim 1 comprising:
the water reservoir further comprising an inner reservoir surface and an opaque color coating; and,
the opaque color coating being superimposed across the inner reservoir surface.

3. The drainable aerating hydroponics system as claimed in claim 1 comprising:
the heat management enclosure further comprising an outer enclosure surface and a reflective coating; and,
the reflective coating being superimposed across the outer enclosure surface.

4. The drainable aerating hydroponics system as claimed in claim 1 comprising:
the water reservoir further comprising a cylindrical-shaped portion and a conical-shaped portion;
the cylindrical-shaped portion being positioned in between the open reservoir end and the conical-shaped portion;
the conical-shaped portion being positioned between the cylindrical-shaped portion and the closed reservoir end; and,
the conical-shaped portion being oriented away from the cylindrical-shaped portion.

5. The drainable aerating hydroponics system as claimed in claim 1 comprising:
a taproot holder;
the taproot holder comprising a lateral brace and an elongated hollow guide;
the perforated basket further comprising a guide-receiving hole and a basket base;
the basket base being positioned opposite the basket rim about the perforated basket;
the lateral brace being terminally connected to the elongated hollow guide; and,
the elongated hollow guide traversing through the guide-receiving hole.

6. The drainable aerating hydroponics system as claimed in claim 1 comprising:
an air pump;
a first flexible tube;
a second flexible tube;
the air pump being externally positioned to the water reservoir;
the air pump being in fluid communication with the aerator through the first flexible tube; and,
the air pump being in fluid communication with the at least one capillary tube through the second flexible tube.

7. The drainable aerating hydroponics system as claimed in claim 1 comprising:
at least one supply tube;
the at least one supply tube comprising a supply inlet and a supply outlet;
the supply inlet being externally positioned to the heat management enclosure; and,
the supply outlet being in fluid communication with the drain valve.

8. The drainable aerating hydroponics system as claimed in claim 1 comprising:
at least one drain tube;
the at least one drain tube comprising a drain inlet and a drain outlet;
the drain inlet being in fluid communication with the drain valve; and,
the drain outlet being externally positioned to the heat management enclosure.

9. The drainable aerating hydroponics system as claimed in claim 1 comprising:
a controller;
a plurality of measurement sensors;
a plurality of environmental sensors;
the plurality of measurement sensors being operatively integrated into the water reservoir, wherein the plurality of measurement sensors is used to monitor a set of measurable conditions within the water reservoir;
the plurality of environmental sensors being operatively integrated into the heat management enclosure, wherein the plurality of environmental sensors is used to a set of environmental conditions around the heat management enclosure; and,
the controller being electronically connected to the plurality of environmental sensors and the plurality of measurement sensors.

10. The drainable aerating hydroponics system as claimed in claim 1 comprising:
a trellis;
at least one light source;
the trellis being externally mounted to the heat management enclosure;
the trellis being positioned adjacent to the reservoir-receiving opening; and,
the at least one light source being mounted offset from the reservoir-receiving opening by the trellis.

11. The drainable aerating hydroponics system as claimed in claim 1 comprising:
a wheel assembly;
the wheel assembly being externally mounted to the heat management enclosure; and,
the wheel assembly being positioned opposite to the reservoir-receiving opening about the heat management enclosure.

12. A drainable aerating hydroponics system comprising:
a heat management enclosure;
a water reservoir;
a perforated basket;
at least one capillary tube;
a plurality of spouts;
an aerator;
a drain valve;
the heat management enclosure comprising a reservoir-receiving opening;
the water reservoir comprising an open reservoir end, a closed reservoir end, a cylindrical-shaped portion, and a conical-shaped portion;
the perforated basket comprising a basket rim;
the at least one capillary tube comprising a tube inlet and a tube outlet;
the water reservoir being mounted within the heat management enclosure;
the open reservoir end being positioned coincident to the reservoir-receiving opening;
the closed reservoir end being positioned offset from the reservoir-receiving opening;
the cylindrical-shaped portion being positioned in between the open reservoir end and the conical-shaped portion;
the conical-shaped portion being positioned between the cylindrical-shaped portion and the closed reservoir end;
the conical-shaped portion being oriented away from the cylindrical-shaped portion;
the perforated basket being mounted within the water reservoir;
the basket rim being positioned coincident with the open reservoir end;
the at least one capillary tube being laterally mounted to the perforated basket;
the plurality of spouts being mounted around the basket rim;
the tube inlet being positioned adjacent to the closed reservoir end;
the tube outlet being in fluid communication with each of the plurality of spouts;
the aerator being positioned within the water reservoir; and,
the drain valve being integrated into the closed reservoir end.

13. The drainable aerating hydroponics system as claimed in claim 12 comprising:
the water reservoir further comprising an inner reservoir surface and an opaque color coating;
the heat management enclosure further comprising an outer enclosure surface and a reflective coating;
the opaque color coating being superimposed across the inner reservoir surface; and,
the reflective coating being superimposed across the outer enclosure surface.

14. The drainable aerating hydroponics system as claimed in claim 12 comprising:
a taproot holder;
an air pump;
a first flexible tube;
a second flexible tube;
the taproot holder comprising a lateral brace and an elongated hollow guide;
the perforated basket further comprising a guide-receiving hole and a basket base;
the basket base being positioned opposite the basket rim about the perforated basket;
the lateral brace being terminally connected to the elongated hollow guide;
the elongated hollow guide traversing through the guide-receiving hole;
the air pump being externally positioned to the water reservoir;
the air pump being in fluid communication with the aerator through the first flexible tube; and,
the air pump being in fluid communication with the at least one capillary tube through the second flexible tube.

15. The drainable aerating hydroponics system as claimed in claim 12 comprising:
at least one supply tube;
at least one drain tube;
the at least one supply tube comprising a supply inlet and a supply outlet;
the at least one drain tube comprising a drain inlet and a drain outlet;
the supply inlet being externally positioned to the heat management enclosure;
the supply outlet being in fluid communication with the drain valve;
the drain inlet being in fluid communication with the drain valve; and,
the drain outlet being externally positioned to the heat management enclosure.

16. The drainable aerating hydroponics system as claimed in claim 12 comprising:
a controller;
a plurality of measurement sensors;
a plurality of environmental sensors;
a trellis;
at least one light source;
a wheel assembly;
the plurality of measurement sensors being operatively integrated into the water reservoir, wherein the plurality of measurement sensors is used to monitor a set of measurable conditions within the water reservoir;
the plurality of environmental sensors being operatively integrated into the heat management enclosure, wherein the plurality of environmental sensors is used to a set of environmental conditions around the heat management enclosure;
the controller being electronically connected to the plurality of environmental sensors and the plurality of measurement sensors;
the trellis being externally mounted to the heat management enclosure;
the trellis being positioned adjacent to the reservoir-receiving opening;
the at least one light source being mounted offset from the reservoir-receiving opening by the trellis;
the wheel assembly being externally mounted to the heat management enclosure; and,
the wheel assembly being positioned opposite to the reservoir-receiving opening about the heat management enclosure.
